(19) United States
(12) Patent Application Publication
(10) Pub. No.: US 2015/0066782 A1
(43) Pub. Date: Mar. 5, 2015

(54) COMPUTER MONITORING, SERVICING, AND MANAGEMENT OF REMOTE EQUIPMENT AND ASSETS

(71) Applicant: PragmaTech Ltd., Toronto (CA)

(72) Inventors: Mark Vainberg, Toronto (CA); Danny Mauti, Toronto (CA)

(21) Appl. No.: 14/465,641

(22) Filed: Aug. 21, 2014

Related U.S. Application Data
(60) Provisional application No. 61/976,171, filed on Apr. 7, 2014.
(60) Provisional application No. 61/870,835, filed on Aug. 28, 2013.

(51) Int. Cl. G06Q 10/00; G06K 19/06

(52) U.S. Cl. CPC G06Q 10/20; G06K 19/06037
USPC 705/305

(57) ABSTRACT

An asset such as a machine equipped with sensors which are connected to a local computer operative to process the sensor signals and transmit current processed signals to a remote central computer running an EPR system. The asset can also be marked with a QR code which may be scanned by a cell phone or mobile computer to connect to a website with a connection to the remote central computer and store and provide information about the asset. The remote central computer comprises a database of information related to the asset and may contain an historic record of past asset sensor signals, service records for the asset, and the like. Based on the received signals and the database information, the central computer maintains information about the asset and determines the asset's needs for operation, maintenance and servicing and sends appropriate messages to service personnel and the like.

### CROSS-REFERENCE TO RELATED APPLICATIONS

This application claims priority of U.S. Provisional Application No. 61/870,835 filed Aug. 28, 2013, and U.S. Provisional Application No. 61/976,171 filed Apr. 7, 2014, the contents of which are incorporated herein by reference.

### FIELD OF THE INVENTION

This invention relates to distributed intelligence computer systems for monitoring and managing assets employing communication between the monitored or managed assets and a central computer and employing digital barcodes associated with the assets and more particularly systems employing multi-dimensional barcodes such as QR codes.

### BACKGROUND OF THE INVENTION

The development in recent years of microprocessors and small computers which can be built into machines and equipment ranging from highly complex business equipment to products found in every home such as refrigerators, furnaces, and the like, and the development of smart cell phones, the Internet and secure wireless networks has allowed such equipment to be conveniently and inexpensively monitored and managed from remote locations for purposes of keeping track of, monitoring, adjusting and maintaining this equipment.

Additionally, high capacity barcodes, such as QR codes, which may include data that automatically connects a scanning device to a particular Internet address or central computer system facilitating bi-directional data exchange, have simplified digital communications between devices marked with these codes and remote computers. Together, these technological advances may be combined to create remote distributed intelligence computer systems capable of greatly empowering the utility of the monitored or managed assets.

### SUMMARY OF THE INVENTION

The present invention is accordingly directed toward a system for maintaining the nameplate and historical information about an asset, as well as monitoring, controlling, and maintaining assets, such as machinery and the like, employing a local monitor computer and a remote central computer.

More particularly, the system may employ barcodes, and more particularly multi-dimensional barcodes such as QR codes, to identify the equipment or assets, to facilitate accurate identification of assets via communication between the assets and the central computer system or a mobile device with built-in barcode scanner, and to enable activities like inventory control, inspections and service calls over the marked asset. A QR code can be attached to any asset and be used to track it in terms of what it is (nameplate information), when it was purchased, from whom, how it was installed, what its warranty is, where it is located, who it belongs to, who serviced it, when and what was done, etc. This technology may be used as asset management and service management tools to maintain and utilize an asset registry and various asset management processes and activities in association with ERP and CRM, and in addition, may be used separately or in conjunction with remote monitoring of equipment, as well as for inventory control of either machines or other assets, as well as inspection of various items like fire equipment, doors, compactors, etc.

The present invention combines intelligent data processing using small computers with wireless communication capabilities with sensors attached to these machines and with central computers receiving timely data from remote devices on their condition, status and needs facilitates smart decision support and management of services, asset management and other related activities based on maintaining historical and other information and using this information for optimal decision making on what to do with these assets. These decisions can range from notifications for services through to requests for maintenance or changes in operating state.

The system employs a monitor, typically consisting of a programmable logic computer (controller or microcomputer) and a cellular wireless modem, to monitor, diagnose and operate the asset. The monitor may include counters and sensors to keep track of, store, and transmit to a central computer various parameters of the serviced machine such as unit ID, time stamp, number of cycles, and operating time since last time serviced and various parameters from sensors, such as current, time, pressure, proximity detectors, ultrasonic sensors, etc.

On a regular basis, the information from the monitor is transmitted over a secure wireless network to a central computer. The central computer receives and processes this information from the remote monitoring systems as well as from web portals associated with the remote equipment and creates an historical record of this information. It can also schedule and execute automatically or manually tasks such as notifications, service requests, alarms, etc. It typically supports web portals, web API, and a message parser. The contents of this computer relating to specific equipment may be accessed via web portals or mobile applications by personnel associated with the particular equipment, provided they are given the rights and access parameters to do so. The server may contain programs that provide notification for the machinery or assets to various service personnel such as haulers or managers or maintenance staff. The central computer can also notify its customers of conditions that they should be aware of, keep track of location and time of pickups or services, and place and monitor service requests and activities. Alternatively, some of these tasks may be associated with a secondary server connected to the primary computer.

Broadly, the combination of remote monitoring of equipment by a central computer to carry out diagnostics, services, and other actions related to the equipment by using information provided by the remote system and rule sets and information stored in the central computer, allow users to keep track and manage as well as get access to information relating to any equipment or asset. In some applications the assets are marked or associated with a digital barcode such as a QR code which may be scanned to establish communication with data residing in a web-based server or cloud ERP platform associated with the central computer to allow users to store, view, and update any information relating to a specific item and to be able to initiate various activities relating to these items. An extract of data residing in a cloud-based ERP can be stored on a mobile device like a smart phone, a tablet or a portable computer and be used to collect or receive data from remote monitoring system associated with an asset or a machine without the need for a wireless or wired connection. Once connected to a network the information on a mobile device can be synchronized with a central computer. The QR codes or the like may also facilitate user authorization so that safe access to the equipment being monitored can be granted and equipment can be depowered for inspection and repowered when the user leaves the equipment location in cases where damage to personnel or equipment is possible if the equipment is accessed while powered.

The barcodes can also facilitate real-time authorization to proceed with a service call if the value of the work and materials exceeds a predetermined approved amount. The time of initiation and completion of service calls can also be transmitted to the central computer for billing purposes.

The systems and apparatus of the present invention can be used with a wide range of machinery, business equipment, and other assets. One of the useful applications of the present invention is for businesses that collect waste streams such as garbage, scrap metal, hazardous waste, and the like which must be hauled away at irregular intervals depending upon the accumulation of the waste at the business. The QR codes associated with the bins or compactors may be used to allow easy communication with the central server which transmits pickup requests directly to haulers, processing facilities, or service providers with a unique reference number for traceability in cases of both monitored and unmonitored equipment such as compactors.

The invention is particularly useful for businesses that use waste compactors or balers. The pickup times for these machines must be adjusted based on combinations of measurement of current parameters and of historical pickup data. The use of these systems will result in a custom time, location, and compactor-specific optimal pickup schedule. The intelligence for determining the pickup time may be distributed between the machine itself and the central computer. The measured parameters which are transmitted to the central computer may include signals from proximity detectors, pressure sensors, various parameters associated with operation of equipment, like current, number of cycles, etc., as well as advanced sensors like liquid level monitors for monitoring liquid height in compactors and motion/infrared detectors to detect pests in the waste bins, so that the services can be automatically requested to deal with various possible scenarios.

The central computer employs algorithms to uniquely forecast when a hauler should anticipate the pickup request. These algorithms are based on a number of parameters, which can be unique for a specific location of a compactor or waste bin, and which include parameters such as:
Weight of the last N (for example 10) pickups as entered into the system by hauler operators using central computer's web portal, email or SMS messages sent to a central computer or by using the QR codes on the serviced equipment to establish a connection to the central computer's database where the weight and other information can be entered easily and in a timely manner
Road load restrictions
Upcoming holidays
Upcoming/current sales or activities resulting in increased volume of waste in the stores or locations of waste collection
Parameters received from remote monitoring system or calculated based on data obtained from remote systems, including:
   Pressure (PSI)
   Days between pickups (for the last N pickups)
   Number of cycles compactor operated since last pickup
   Average PSI/day for the last N pickups
   Average number of days between pickups for the last N pickups

The preferred embodiment of the system employs distributed intelligence involving communications from the remote monitors largely based on sensors associated with the remote assets which are communicated to the central computer on a periodic basis. The data typically comprises time stamped sensor values which are collected in the database at the central computer in a file associated with that particular Remote Monitoring System (RMS). Over time these stored values from the associated RMS form an historical database which may be used in conjunction with trending algorithms based on historical and other relevant data by the central computer to arrive at optimal decisions relative to operating, servicing and maintaining equipment being monitored by the RMS, as well as to looking after RMS itself.

For example, given the embodiment of a compactor or baler serviced based on decisions made at the central computer, the pressure which must be exerted on the ram of the compactor or baler each time it performs its compacting operation may be transmitted to the central computer. When that pressure reaches a sustained (rather than a spike) predetermined trigger point indicating that the unit may require a service call by a hauler which will empty the machine or a bin, the central computer may analyze its database to determine whether factors other than the ram pressure determine the need for a service call by a hauler. For example, one of the factors stored in the central database is the number of cycles that the remote machine has undergone before servicing was required in the past. If the triggering pressure is achieved but the number of cycles is unusually low, the machine may require a service call by a technician rather than an emptying operation by a dispatched hauler or will postpone service/pickup request until the minimum acceptable number of operating cycles is reached to make sure that the desired weight of the compactor is obtained to minimize the number of trips by haulers. This minimum number of cycles can be determined by an algorithm taking into account the average number of cycles over the previous N pickups (where N is equal for example 10).

Communication between the central computer and each of the remote monitor computers is typically over a machine-to-machine virtual private network which is a secured virtual private network over a cellular carrier. As opposed to using the Internet for this communication, the virtual private network cannot be easily hacked.

### BRIEF DESCRIPTION OF THE DRAWINGS

Other objects, advantages, and applications of the present invention will be described in connection with the following preferred embodiments of the invention. The description makes reference to the accompanying drawings in which:

FIG. 1 is a block diagram of a preferred embodiment of the system of the present invention showing in detail one of a plurality of remote monitoring systems (RMS), each servicing a different asset, connected to a central server;

FIG. 2 is a schematic diagram illustrating an embodiment of the invention based on the embodiment illustrated in FIG. 1 further including a cloud based customer portal for accessing the stored data on the platform server and a notification server, driven by decisions reached by the central server in analyzing its data, which can be used to notify its customers and service providers about various conditions and situations at the monitored assets and may be used to arrange for service for the monitored machines;

FIG. 3 is a flowchart of the data flows from remote monitoring systems to central computer showing the workflows associated with data collection and notifications which can be automatically or manually triggered by software to enable the services and activities performed by the preferred embodiments of the system. In addition, FIG. 3 shows functionality of the system enabling utilization of barcodes such as QR codes to initiate various actions by customers or service providers at the location of assets/machines ensuring accuracy of service requests and service activities as the barcodes are uniquely associated with assets; and

FIG. 4A and its continuation FIG. 4B are flowcharts illustrating how QR codes may be used in connection with the present invention.

### DETAILED DESCRIPTION OF PREFERRED EMBODIMENTS OF THE INVENTION

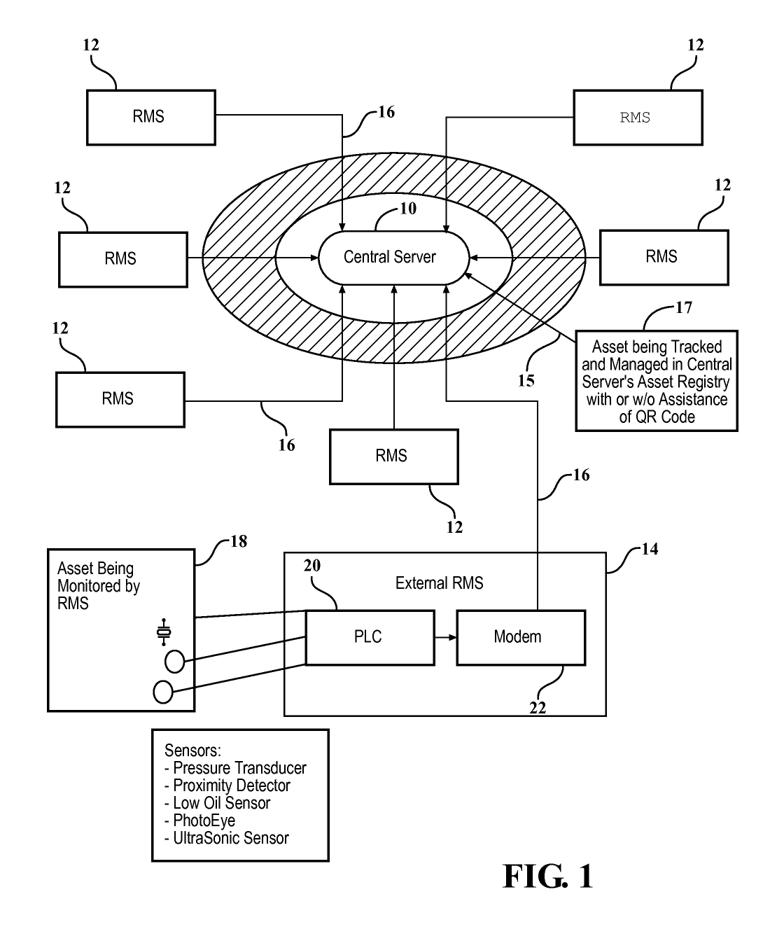

While in accordance with the present invention a central computer would be capable of monitoring a single machine or other asset at a remote location, the same central server generally is utilized to service a plurality of remote assets. Referring to FIG. 1, a single central computer 10 is illustrated as servicing a number of remote monitoring systems (RMS) 12. One of these remote monitoring systems 14 is illustrated in more detail than the others.

The communication paths 16 between each of the remote assets 12 and the central computer 10 may be in any form capable of transmitting digital signals at the required rates such as wired, wireless, cellular, or the like. In the preferred embodiment of the invention these communication paths take the form of a machine-to-machine virtual private network which is essentially a secure local area network constructed over a cellular carrier. This network is not easily accessible to third parties and is more secure than public networks.

The RMS 14 illustrated in FIG. 1 is shown as servicing a waste compactor 18. As indicated, the waste compactor may be equipped with a plurality of sensors such as a pressure transducer, a proximity detector, a low oil sensor, various photo-eye detectors, and ultrasonic sensors. The signals from these units are provided to a programmable logic computer (controller—PLC or microcomputer) 20 which connects via the virtual private network 16 to the central computer 10 through a modem 22. The PLC preprocesses the signals, converting them to digital form if necessary, and transmits them to the server 10 through the modem 22 and network 16 at periodic intervals. Alternatively, the central server may initiate communications with remote monitors and collect the data using its own schedule and rules.

The computer 10 receives and processes these sensor signals and other data or service requests from remote monitoring systems, as well as from web portals.

The computer 10 stores the sensor signals received over time to create an historical record of the signals, and uses that historical record, along with other factors, to determine what actions are warranted or required based on accumulated data and algorithms using this data.

The computer 10 is in contact with each of the remote monitoring systems through the virtual private network 16 to collect, store and process information received from remote assets and to communicate required actions to customers or service providers via emails, SMS messages or web portals. It is also in contact with any other parties who may be required to manage and approve services of the equipment monitored by the RMS or RMS itself such as equipment owners/managers, haulers, maintenance people, and the like.

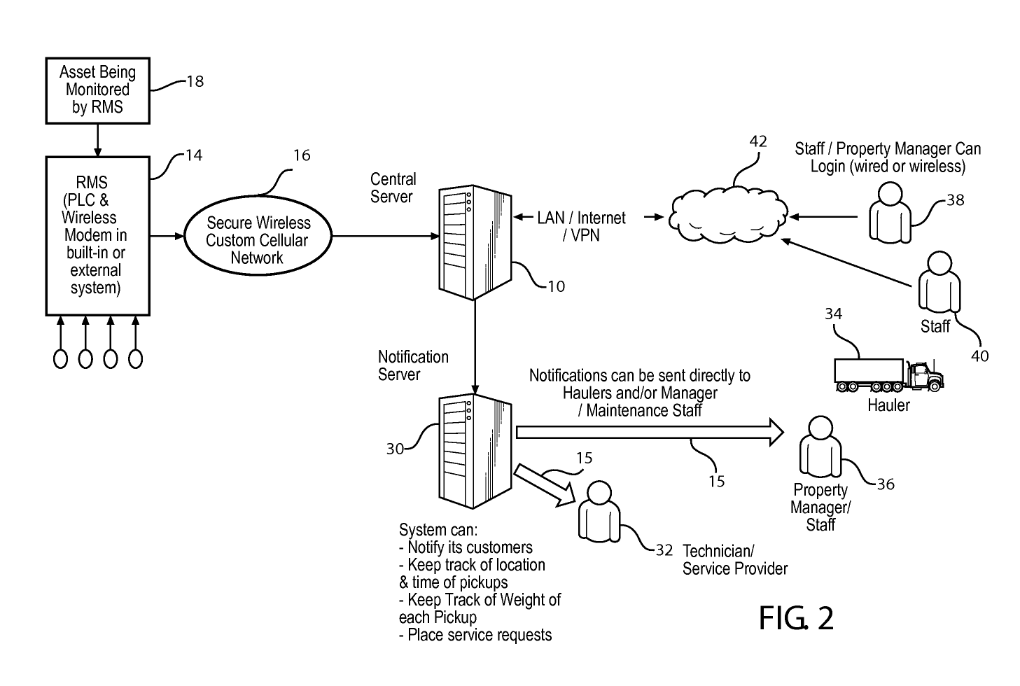

FIG. 2 illustrates the environment of the central computer 10 shown as receiving the sensor signals from an RMS 18 through the cellular custom virtual private network 16. The server, of course, may receive signals from a number of RMS units.

The central computer 10 performs an analysis on the signals received from the RMS 18. In the case where the RMS constitutes a waste collection system requiring pickup by a hauler at variable times, the central computer can automatically select and schedule pickup requests and notifications to interested parties based on a number of factors relating to the past data for that RMS, as stored in a memory associated with the central computer and the current signals from the RMS. It also stores other data relating to pickup such as specific hauler response time, load restrictions on roads during certain seasons, historically higher or lower consumption periods such as holidays and the like, weather conditions, and similar factors. Based on these factors the server determines the necessity for a pickup of the equipment (compactor for example) being monitored by the RMS 18 and sends that information to a notification server 30. In particular systems the functions performed by the notification server can be performed by the central computer itself. The notification server notifies the customer or service provider associated with the particular equipment being monitored by the RMS of the pickup time over a VPN 16, keeps track of the location and time of the pickups, and places service requests such as to a hauler 34 or a property manager or associated staff 36 of the time and location of the scheduled pickup.

Other interested and authorized parties such as a property manager 38 or the manager's staff 40 can communicate with the central computer 10 through a web portal 42 connected to the central computer by a VPN, to access any pertinent data from each of the RMS units.

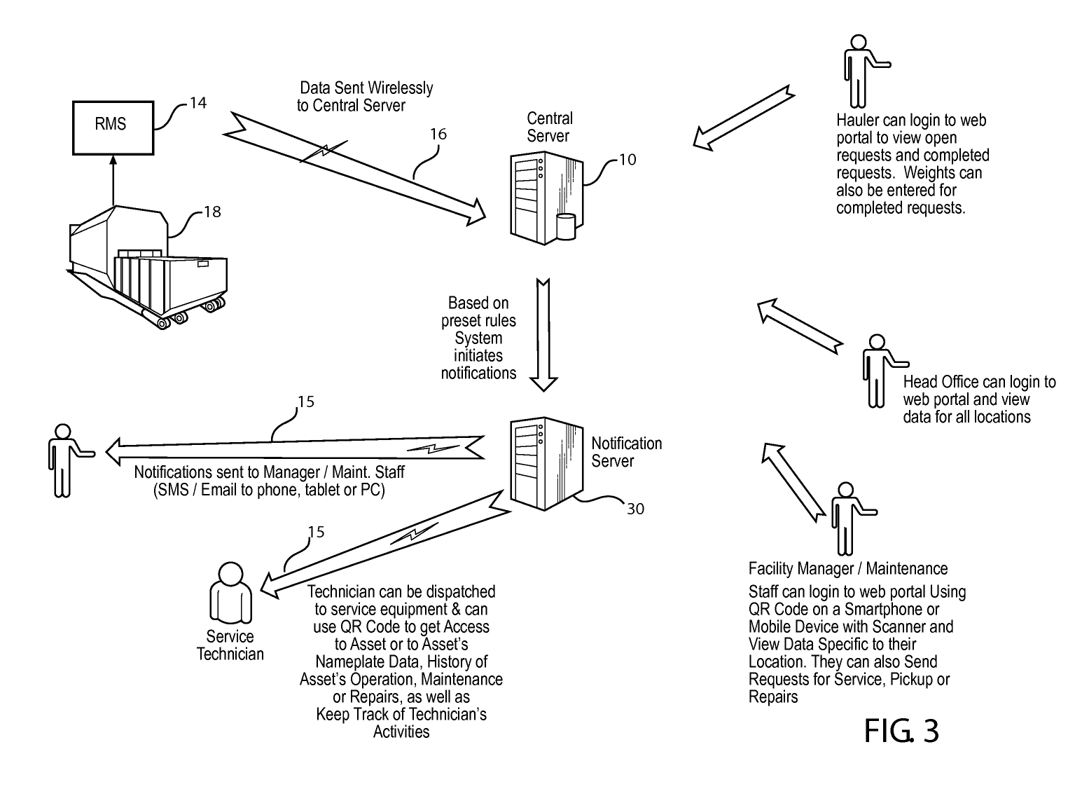

FIG. 3 illustrates the data and information workflows associated with remote monitoring of equipment demonstrating how the wireless network may be used for remote system monitoring equipment to communicate with the central server 10 to send, obtain and update information relative to said equipment or an asset, which then allows the central server to initiate required actions relative to the asset.

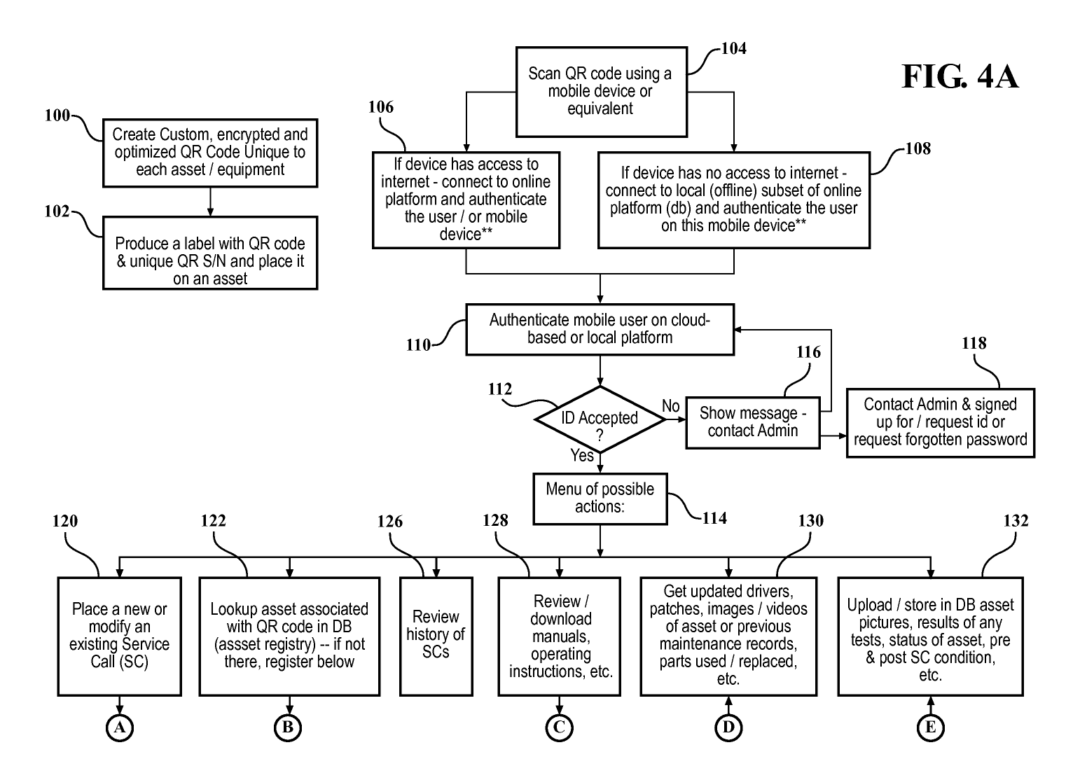

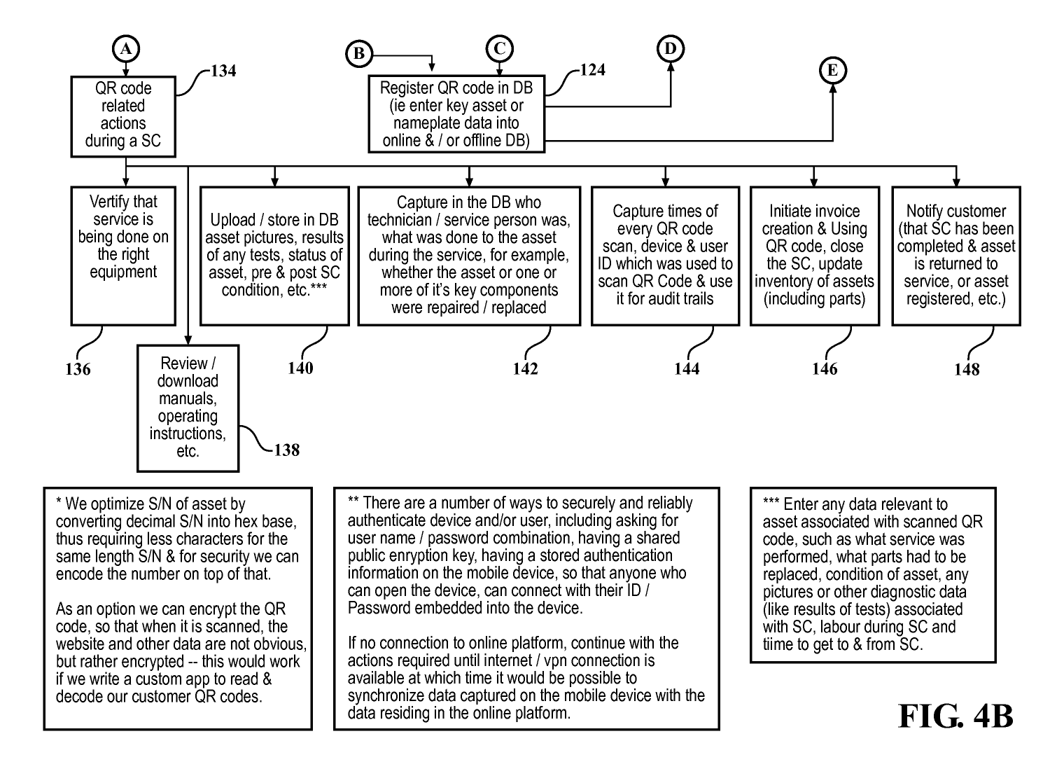

FIGS. 4A and 4B illustrate how QR codes may be used for managing assets and services using the wireless network in conjunction with mobile devices, such as smart phones or tablets, and central computer/online platform. As indicated in block 100 of FIG. 4A, the initialization of the system requires the creation of a custom encrypted QR code unique for each piece of equipment or asset as shown at block 100. Then a label with the QR code is created at block 102 and placed on the asset in a position so that it may be scanned or associated with an asset if it is a digital asset, such as a picture diagram, document or any other digital file stored in any digital form by any means, such as on a hard disk, DVD, memory stick, online, etc. To communicate with the central server (10 in FIG. 3) the QR code is scanned using a mobile device with a scanner, typically a cell smart phone, any scanner equipped mobile device, a PC with a scanning application, or entered via a web portal of the central computer or online platform. The QR code contains data identifying the asset and identifying the URL of the website or online platform/central computer associated with the computer system 10. This is done at block 104. Assuming the device has access to the Internet, it then connects to the online website associated with the central computer 10. The scanning device also transmits identification for the user of the scanner. These are sent to the central computer or website at 106. Alternatively, as shown at block 108, if access to the Internet is not available, connection can be made through a local extract of online platform created to authenticate mobile user.

When the website or its local extract receives the message from the scanner, at block 110, the device and/or the user are authenticated. This may be done by inquiring as to the user's name or password or through a shared public encryption key with stored authentication information.

Assuming that the authentication is positive, as indicated at box 112, the website or its local extract sends or provides a menu of possible actions to the mobile device or online application at block 114. If the authentication is not accepted, additional contact with the scanning device is initiated at blocks 116 and 118.

The menu of possible actions 114 includes actions like placing a new or modifying an existing service call at block 120 or looking up or entering the information related to the asset associated with the QR code in a database of registered assets. If the asset is not listed in this asset registry at block 122 and scanned QR code is not found, messages are generated which will allow the registration of the QR code in the database at block 124. A further possible action is a review of the history of the service calls or other actions associated with the assets scanned at block 126; reviewing and allowing the download or upload of manuals and operating instructions at block 128; retrieving or updating information relating to the asset such as getting updated drivers, patches, videos, and maintenance records at block 130; and uploading and storing or downloading asset pictures in the asset database (asset registry), results of any tests, status of the assets, pre and post service call condition, etc. at block 132.

In order to place a new service call or modify an existing one, block 120 connects to a QR code setting forth the actions performed during the service call, at 134. First the system verifies that the proper equipment to be serviced is being specified at block 136. The system user may then review or download manuals, operating instructions, and the like at block 138. At block 140 the system may upload and store from the device with the scanner or a computer connected to the Internet into the database the pictures associated with the asset, results of any tests, status of the asset before and after the service call, etc., as well as download the same information from the online/offline database to a mobile device or a computer with a scanner. At block 142 the system captures in the database who performed the service call, what was done to the asset during the service, and whether any of the components of the asset were repaired or replaced during the service call. The system also captures times of each QR code scan of the device and the user ID which was used to scan the QR code and uses it for audit trails at block 144. The system can then initiate and carry out invoice creation, close the service call, and update the inventory of assets including parts at block 146. In addition, the system can capture how the asset has been operating with information like how many operating cycles the asset went through up to the time of the service call, etc. to facilitate analysis associated with operation, maintenance and repair of the said asset associated with QR code.

The QR code marking on the asset or associated with the digital asset and the associated device with the scanner allow the transfer of necessary information related to the asset and any actions like the service call to the system for storage, and provide the necessary directions to the servicing technician, while recording all the information for later review in connection with future service calls. They also may handle the administrative functions of generating an invoice and advising the client of the condition of the asset.

### General Operation of the System

The RMS units analyze data from the sensors associated with the asset and the PLC forming part of the RMS automatically generates custom error or alarm codes corresponding to predetermined recognized conditions, such as low oil alarm, disconnected hoses, blocked photo-eye or ultrasound sensor. The data collected by the sensors as well as these error/alarm codes are then transmitted to the central computer 10 via a virtual private network—VPN 16 (FIG. 1) to the central computer/server 10. The central computer/server 10 then sends an appropriate message to the notification server 30 and notifications are sent via the VPN or other communication channels to the designated users of the system via emails or SMS messages or posted to the web portals. These automated processes reduce the number or totally eliminate the service calls to technicians or other service providers and allow local site staff in some situations to fix the problem without a service call using diagnostics information received from the server possibly resulting in service call trip avoidance.

In the application of this invention related to waste industry the unique features of the remote compactor monitoring system include the following:
a) A hauler portal showing haulers which bins are either full or close to be full (in percent of fullness).
   The hauler portal provides haulers with not only the ability to enter weights associated with each waste pickup (and associated Purchase Order—PO), but also provides the users of this web portal with ability to optimally schedule current and future pickups as the hauler portal display daily PSI of compactors which are getting close to being full. Once the hauler enters the weight associated for a specific pickup at specific site, the system then has the ability to close the PO of this service request facilitating audits of waste collection operations. The same data is useful to minimize any errors when reconciling hauler invoices.
b) The platform has the ability to support multiple waste streams within the platform, like general waste, organics, recyclables, hazardous waste, etc. This allows discrete management and alerts/notifications associated with specific waste stream.
c) Automatic advanced diagnostics of error and alarm conditions using data from sensors monitored by RMS and knowledge base in the central computer.
   Each RMS analyzes data from its associated sensors and the PLC automatically generates custom error or alarm codes corresponding to predetermined recognized conditions, such as low oil alarm, disconnected hoses (when the measured pressure spikes, but compactor does not operate), blocked photo-eye or ultrasound sensor (identifying that waste is piled up in front of the sensor and needs to be removed or the sensor is malfunctioning, etc.). These error/alarm codes are then transmitted to the central computer and notifications are sent to the designated users of system via emails or SMS messages.
d) A self-improving waste compactor/bin monitoring system which automatically adjusts pickup requests and notifications via email or SMS based on combinations of historical and current parameters and constraints.

In more detail, the system can automatically adjust pickup requests and notifications based on:
1) past and current pickup data (e.g. correlate weights measured at pickup with trigger level psi specific for each compactor and other parameters and constraints like minimum number of cycles, load restrictions on the roads during seasons, etc.)
2) historically higher or lower consumption periods (for example periods of large volume sales like Thanksgivings or Christmas sales)
3) road restrictions (some jurisdictions introduce weight restrictions on the roads during spring and fall conditions, as for example is done in Alberta)
4) geographic location
5) weather conditions
6) specific hauler response time, etc.
7) store characteristics, like store/site square footage, location, other parameters specific to equipment location
8) other analytical parameters which may have been or will be developed and which result in a custom time, location, and compactor-specific optimal pickup request trigger (notification)
As more and more data is accumulated for each location, a progressively more accurate algorithm is developed and implemented to automatically optimize functionality of waste collection reductions by the system. Initial implementation is an algorithm where a historic relationship between weights at pickup and percent full (measured sustained pressure divided by maximum allowable pressure) is expressed in a best fit linear relationship to be able to extrapolate at which point the next pickup request is to be sent. This formula is initially derived for each monitored location by considering a set number of pickups (for example last 10-20 pickups), but as multiyear data is accumulated, the formula is then based on the historic data for a shorter period of time, which may include anywhere between 1 to 4 pickup intervals.
e) The above methodology and data provide system users with an ability to cross reference pickup and weight data using the system to quickly compare what is being reported by haulers in their invoicing versus the actual recorded data of when pickup occurred and whether they were after request for pickup was initiated by the system or the hauler picked the bin early. The system also escalates notifications for pickup if the hauler is not acting within set time intervals.
f) Minimum cycles rules for frozen compactors
g) If the pressure readings in an RMS reach a sustained predetermined trigger level to initiate request for waste pickup, but the number of cycles the compactor operates is low, it could be caused by cold weather conditions when the compactor may be frozen. To avoid requesting a false pickup, the system checks to see if the minimum number of cycles required to trigger the pickup has been reached and if not, the request for pickups will not be initiated until the minimum number of cycles is reached. The minimum number of cycles is calculated by first calculating an average number of cycles over the last 10 pickups and then by reducing the average number of pickups by a constant offset value, thus making sure that, on average, froze compactor conditions are identified and requests for pickup are only initiated when compactor is close to being full. In the absence of any historic data, the minimum value on the minimum number of cycles is preset manually at a value derived from the system's experience with similar sites.

The combination of the distributed intelligence between the RMS and the central computer, and the supporting communication system enabled by the QR codes, allows the user to:
Carry out diagnostics, services, and other actions related to this equipment by using information provided by the remote central system.
Keep track and manage, as well as get access or update the information related to any asset/equipment/item which may or may not be associated with a unique QR code with data residing in a web-based, service, or cloud platform to allow users to store, view, and update any information related to a specific item and be able to initiate various activities related to these items.
Facilitate user authorization so that a safe access to the equipment can be granted and equipment can be repowered when the user leaves the equipment location where a danger is possible.
Facilitate real-time or semi-real-time authorization to proceed with a service call if the value of work and materials exceeds a predetermined approved amount.

These capabilities enable a wide variety of possible applications, such as the following:
1. User notices that a specific piece of equipment is malfunctioning or not functioning as required. User scans QR code, authenticates himself as authorized user on the remote web-based platform (system), and is now able to carry out web-facilitated equipment diagnostics to help identify the cause of the problem and fix it or place a service call with more understanding of what is wrong. For example, a sensor like a proximity detector is obstructed with something, a web-based system will identify this as one of the possibilities and instruct the user to check if indeed there is an obstruction which can be removed, thus solving the problem. If after a series of system suggestions, the problem is still persisting, the user will be able to place a service call, but in this case the technician coming to service equipment will already know that simple steps have been taken and not the likely cause of the problem. The system can be programmed to show the user a series of possible causes of problems and provide suggestions on how to determine the root cause of the problem or how to fix/mitigate the existing condition using pictures, diagrams, and even videos on how to do simple procedures to address possible issues.
2. Equipment is not functioning as usual and user needs access to location where equipment is located, but to guarantee safety, equipment, such as compactor, has to be disabled from operation to avoid possible injury to unqualified personnel. User scans the QR code to access the location with equipment and if the correct authorization is entered, the equipment is powered down by the remote platform and the access to the equipment location is granted. After checking the status of equipment, and possibly correcting a simple issue, the equipment will be allowed to go back to service after the person leaves the location and initiates the operation by first scanning the QR code at the location interlock to indicate to the system that it is possible to put equipment back to service.
3. A technician is dispatched to service equipment and upon arrival the technician scans QR code and enters into the system results of his/her assessment of situation (i.e., what needs to be done, like replace the motor, etc.) and the platform software determines that the cost of labor, materials, replacement parts, travel costs from the service center to the equipment location, etc. exceeds a predetermined, preapproved amount. The system then automatically requests a real-time or urgent approval for the estimated amount. The system sends out a request for approval to the person(s) authorized to approve this PO using email, SMS, phone call, or any other means programmed and waits for the PO authorization. If programmed, the request for authorization gets escalated to another level/person in the organization. If approval is not granted within a specified period of time, the technician leaves the premises, but the data on service call requirements and communications to approve the service call and all supporting information is captured in the system and provided to relevant staff for further actions.
4. The system can also be used to capture the time when a service technician or any service/staff/subcontractor arrives at a certain piece of equipment or asset, and when this person finishes their task (can be a service call to repair/replace/refurbish equipment/machinery/asset, inventory check, asset status assessment, inspection, etc.), thus allowing capture of information on who did the task, how long it took, what occurred during the task, what if any materials/equipment were used to repair/replace/refurbish/inspect the asset/equipment, etc.). The data collected in this manner can allow companies to analyze how efficient the labor of staff/subcontractors is, as well as start doing billing by the minute or any other timeframe versus a fixed fee for a service call or other task (cleaning, inspection, inventory control, adjustments, repairs, etc.).
5. The system can be used to automate collection and management of data associated with safety and security inspections for regulatory, environmental, and other business and/or government compliance, for example for equipment like fire protection systems, elevators, entrance and exit doors, oil or chemical storage facilities, hazardous materials storage facilities, etc. Using QR codes in conjunction with an ERP and CRM platform allows to not only keep track and record an audit trail of activities, like inspections or inventory control, but also who did what, when and where, and what deficiencies, if any were found and recorded, what actions initiated, and how they were addressed. The rule-based decision support framework can then be established to, if and when needed, escalate priorities of notifications and activities, and initiate noncompliance actions (for example, send a message to stop using an elevator with expired operating license, or do not allow a subcontractor to work until their license is renewed).
6. Unique QR codes can be assigned to any equipment/asset/item in work or home environment which would allow the asset owner/operator to keep track of nameplate data of this item (i.e., manufacturer, model, S/N, date of manufacturing), as well as date of installation, warranty period, installer/service person/company, their contact information, history of service calls, etc. If at any given time the item needs services, replacement, update (for example a smart TV or computer may need firmware update), scanning QR code will bring the user to the platform where, after authentication, the user will be able to see history of recalls, updates, user manuals, manufacturer's notices/updates, other service providers authorized by manufacturer to service the asset/equipment, who and where can provide replacement parts, etc.

Having thus described our invention, we claim:

1. A distributed intelligence system for monitoring the status of an asset to assist in the service and maintenance of said asset, comprising:
a central computer storing information relating to said asset;
sensors connected to said asset to generate signals related to the current status, condition, and/or operation of the asset;
a local computer associated with said asset operative to receive said sensor signals and perform operations on said signals;
a local modem connected to said local computer facilitating communications and data exchange between the local computer associated with said asset and the central computer;
a network operative to transmit said current sensor signals and said asset information as operated on by said local computer and encoded by said modem to the central computer;
a database associated with the central computer for receiving over said wireless network and storing said current sensor signals and said information relating to said asset to create an historical database of said sensor signals and other information relating to said asset;
the central computer being operative to analyze the received current sensor signals and the stored database of historical sensor signals and other information and to make decisions as to the need for servicing, maintenance, inventory or inspection of the asset and to notify service providers for the asset and personnel responsible for the operation of the asset in order to monitor, operate, service and maintain said asset;
a barcode associated with the asset, readable with a scanner equipped computer, the barcode comprising an identification of the asset and the Internet URL of a website associated with the central computer, enabling communication between the scanner equipped computer and the central computer so that the scanner equipped computer can interrogate the database and add or edit information related to the asset to the database; and
a barcode associated with the asset, readable with a scanner equipped computer, the barcode comprising an identification of the asset and mobile device having an extract of the central computer's database containing information relating to the said asset, enabling authentication of user of mobile device and collection and exchange of information related said asset associated with the said unique barcode with ability to synchronize and update information related to said asset and obtained on mobile device to the central computer when the link to central computer is established at a later date.

2. The system of claim 1, wherein the scanner equipped computer is a cell smart phone equipped with a barcode scanning capability.

3. The system of claim 1, wherein the barcode is a QR code.

4. The system of claim 1, wherein the wireless network is a secure nonpublic custom network connecting the central computer to the local computer monitoring the asset and wherein a public non-secure wireless or wired network is used to communicate with service and maintenance personnel for the assets to facilitate activities such as notifications and requests for services.

5. The system of claim 1, wherein the information relating to the asset stored in the central computer comprises operating, maintenance and service history of the asset.

6. A distributed intelligence system for monitoring the status of a machine to assist in the service, operation and maintenance of said machine, comprising:
a central computer storing information relating to said machine, said information comprising an historical record of the service and maintenance of the machine;
sensors connected to said machine to generate signals related to the current status, condition, and/or operation of the machine;
a local computer associated with the machine operative to receive said current sensor signals and perform operations on said signals;
a wireless network operative to transmit said current sensor signals as operated on by said local computer to the central computer;
a database associated with the central computer for receiving over said wireless network and storing said current sensor signals and said information relating to said machine to create an historical database of said sensor signals and said information relating to said machine; and
the central computer being operative to analyze the received current sensor signals and the stored database of historical sensor signals to make decisions as to the need for operating, servicing and maintenance of the machine and to notify service providers for the machine and personnel responsible for the operation and maintenance of the machine in order to operate, service and maintain said machine.

7. The distributed intelligence system of claim 6, wherein the machine is a waste collection system requiring a periodic pickup of the waste by a hauler at irregular intervals and the central computer notifies a hauler when pickup is required based on the central computer's analysis of the current sensor signals received by the central computer over said wireless network from the local computer and information in said historical database and other relevant information related to said machine.

8. The distributed intelligence system of claim 7, further comprising a barcode associated with the machine readable with a scanner equipped computer, the barcode comprising an identification of the asset and the Internet URL of a website associated with the central computer, enabling entry and maintenance of information related to said machine to enable storage and communication of this information between a mobile computer and the central computer.

9. The distributed intelligence system of claim 8, wherein the scanner equipped computer comprises a cell phone.

10. The distributed intelligence system of claim 7, wherein the waste collection system further comprises a baler for various types of waste, the baler having a ram and the sensor signal comprises the pressure exerted by the ram on the waste and a switch counting number of bales created during the operation of the baler since last waste pickup. The sensors associated with the baler send the data to the remote monitoring system associated with a compactor located in the vicinity of the baler using wired and wireless connections and thus may provide status, like number of bale counts created, and condition of the baler to the central computer.

11. The distributed intelligence system of claim 6, further comprising a barcode associated with the machine, readable with a scanner equipped computer, the barcode comprising an identification of the machine and the Internet URL of a website associated with the central computer enabling communication between the scanner equipped computer and the central computer so that the scanner equipped computer can interrogate the database and add information relative to the machine to the database; and the central computer is operative to send signals to the machine, to disable the machine during periods of servicing, for safety purposes, and to re-enable the machine at the termination of the service operation.

12. The distributed intelligence system of claim 10, wherein a service operator may utilize a scanner equipped computer to transmit information to the central computer relating to the time of initiation of a service operation and the time of completion of the service operation, such information being used by the central computer to develop billing related to the service operation.

13. The system of claim 6, wherein the wireless network is a secure, nonpublic, custom network connecting the central computer to the local computer and wherein to service and maintenance personnel for the machine.

14. The system of claim 6, wherein the public or private Internet or other networks are used to facilitate notifications and alarms created by central computer and delivered to users of the system via emails, SMS, web portals or custom applications running on mobile devices and which can be used with or without utilization of QR codes.

15. The distributed intelligence system of claim 6, wherein said historical database of information related to the machine comprises an audit trail of past actions relative to the machine as well as all nameplate data of said machine.

16. The distributed intelligence system of claim 15, wherein the past actions relative to the machine comprise the results of past inspections of the machine for compliance with governmental regulations.

17. The distributed intelligence system of claim 6, further comprising a wireless or wired local or wide area network or public internet operative to transmit notifications and alarms from said central computer to system customers and service providers and to facilitate communications between users with mobile devices and computers and the central computer initiating communications via mobile devices, computers connected to networks which can connect to central computer and via utilization of barcodes to authenticate users and devices and to provide means for easy and reliable access to data on central computer associated with assets associated with specific scanned barcodes.
